(19) United States
(12) Patent Application Publication
(10) Pub. No.: US 2013/0006737 A1
(43) Pub. Date: Jan. 3, 2013

(54) LOCATION AWARE MOBILE GAME REWARD SYSTEM FOR ENCOURAGING REAL-WORLD ACTIVITY

(75) Inventor: Adam Goldberg, Calabasas, CA (US)

(73) Assignee: Clandestine Networks, Inc., Calabasas, CA (US)

(21) Appl. No.: 13/536,656

(22) Filed: Jun. 28, 2012

Related U.S. Application Data
(60) Provisional application No. 61/502,001, filed on Jun. 28, 2011.

(51) Int. Cl. G06Q 30/02

(52) U.S. Cl. 705/14.12

(57) ABSTRACT

There is disclosed a method and apparatus for enabling a location-aware mobile game reward system for encouraging real-world activity. The method includes sending an electronic notice of a reward available in a physical location to a mobile application operating on a mobile device, the mobile application having enhanced functionality available to be enabled by the reward and receiving location data indicating that the mobile application is operating online and currently at the physical location. The method further includes receiving interaction data indicating that a user of the mobile application has interacted with the mobile application in the physical location so as to obtain the reward and crediting the mobile application with the reward thereby enabling the enhanced functionality of the mobile application.

### RELATED APPLICATION INFORMATION

This patent claims priority from pending U.S. provisional patent application Ser. No. 61/502,001 entitled “Augmented Reality Game” filed on Jun. 28, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a location-aware mobile game reward system for encouraging real-world activity.

2. Description of the Related Art

Mobile gaming has increasingly relied upon a free-to-play model in which a user is provided a game with basic functionality free of charge. For small or incremental fees, additional functionality is enabled within the game. For example, a basic game may be further enhanced by access to special items or the game's progress may move more quickly upon receipt of payment. These payments are typically completed using virtual currencies. In some free-to-play games, these currencies may be earned through continued player interaction or through payment of fees. In other games, only one type of currency is available. In still other games, the two types of virtual currencies are used, one for real-money currency, the other for time-based or action-based currency.

Location aware applications are also present in the art. The most well-known applications enable a user to “check-in” at a particular location. Over time, a user may be given a particular status or title at a location after repeated check-ins. Other location-aware applications enable users to know when their “friends” are within a certain predetermined distance of their location. For example, if a user checks-in at a location, a “friend” of that user near that location may receive an update indicating as much so that user may contact them to meet. Still further location aware applications enable users at a location to receive coupons, free items, or other rewards if they check-in at a location.

### DESCRIPTION OF THE DRAWINGS

FIG. 1 is a diagram of a location-aware mobile game reward system for encouraging real-world activity.

FIG. 2 is a diagram of a computing device.

FIG. 3 is a functional diagram of a location-aware mobile game reward system for encouraging real-world activity.

FIG. 4 is a flowchart of a location-aware mobile game reward system for encouraging real-world activity from the perspective of a reward server.

FIG. 5 is a flowchart of a location-aware mobile game reward system for encouraging real-world activity from the perspective of a mobile application.

FIG. 6 is an example screen of a mobile application showing a reward notification.

FIG. 7 is an example screen of a mobile application showing a reward availability map.

FIG. 8 is an example screen of a mobile application showing a reward claim functionality.

FIG. 9 is an example screen of a mobile application showing an augmented reality reward claim functionality.

FIG. 10 is an example screen of a mobile application showing an alternative augmented reality reward claim functionality.

FIG. 11 is an example screen of a mobile application showing an award of a tangible reward.

FIG. 12 is an example screen of a mobile application showing a current reward point status.

FIG. 13 is an example screen of a mobile application showing a reward point redemption.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

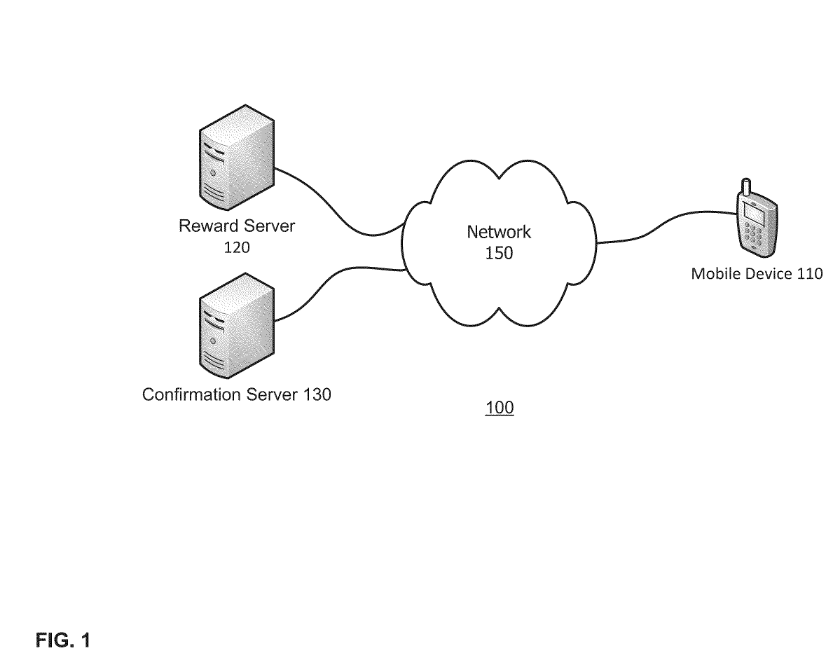

Referring now to FIG. 1, a diagram of a location-aware mobile game reward system 100 for encouraging real-world activity is shown. The system 100 includes a mobile device 110, a reward server 120 and a confirmation server interconnected by a network 150.

The mobile device 110 is connected to the network. The mobile device 110 is shown as a smart phone, but may take many forms. The mobile device 110 may be a personal computer, lap-top computer, mobile device, a tablet PC, a personal digital assistant, a smartphone, a “dumb” phone, a feature phone, or any other location-aware device capable of accessing the network 150.

The reward server 120 provides notifications of available rewards and provides rewards to the mobile device 110. One reward server 120 is shown, but the reward server 120 may include one or more servers capable of providing offers in conjunction with one another. The reward server 120 may include one or more processors.

The confirmation server 130 may be used by a third party company making rewards available to mobile device 110 in order to confirm that the reward offered by the reward server 120 was claimed in a proscribed manner by the mobile device 110. The confirmation server 130 may access or utilize the reward server 120 to obtain proof of claimed rewards.

The network 150 may take the form of a local network, a wide area network, the Internet or any number of other networks. The network 150 may be implemented locally by physically connected computers or may be distributed over a wide area.

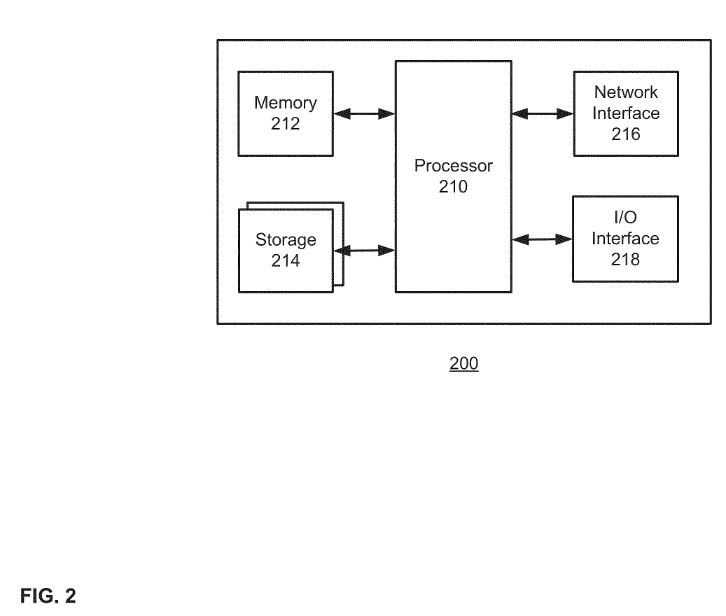

Turning now to FIG. 2, there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 150.

The I/O interface 218 interfaces the processor 210 to peripherals (not shown) such as displays, keyboards and USB devices.

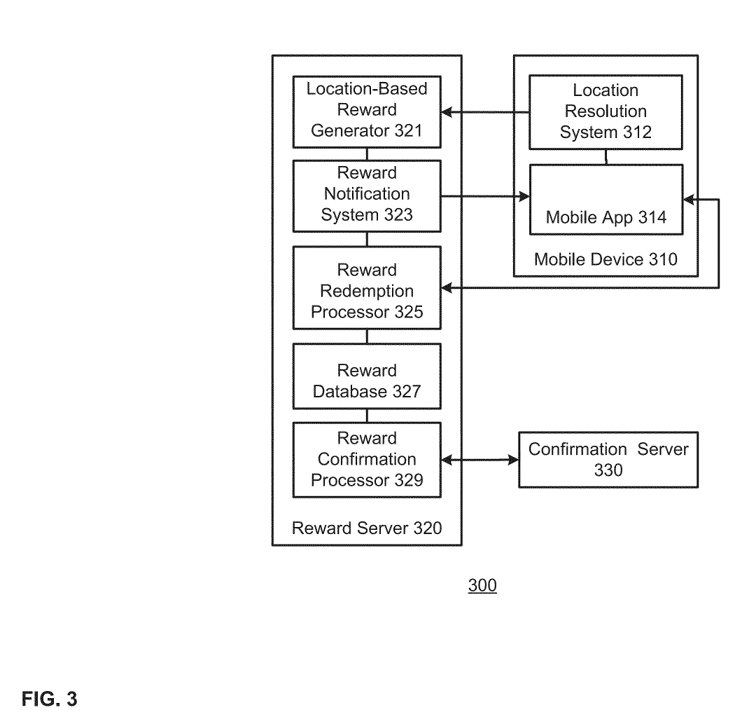

Turning now to FIG. 3, a functional diagram of a location-aware mobile game reward system 300 for encouraging real-world activity. The system 300 includes a mobile device 310, a reward server 320 and a confirmation server 330. The mobile device 310 includes a location resolution system 312 and a mobile application 314. The reward server 320 includes a location-based reward generator 321, a reward notification system 323, a reward redemption processor 325, a reward database 327 and a reward confirmation processor 329.

The mobile device 310 includes a mobile application 314 with access to a location resolution system 312. The mobile application 314 is an application that has enhanced functionality available to be unlocked by a user. For example, the mobile application 314 may be a free-to-play application with additional functionality that may be unlocked through payment of a fee (such as a microtransaction), continued interaction with the mobile application 314 or in other ways. This enhanced functionality may be further application modes of use, additional functions, additional capabilities of existing functions. If the mobile application 314 is a game, the enhanced functionality may be additional available characters, items, character enhancements, in-game currency, discounts, increased speed of the game's operation and similar enhancements.

The location resolution system 312 may be used by the mobile device 310 and the mobile application 312 in particular to obtain location information for the mobile device. The location resolution system 312 may be or use a global positioning system (GPS). Alternatively, the location resolution system 312 may rely upon triangulation based upon available WiFi hotspots and/or GPS, commonly known as assisted GPS or may rely upon other proprietary signals. The location resolution system 312 may poll a network and rely upon an external resolution system, such as the network informing the mobile device 310 of the location.

The reward server 320 includes a location-based reward generator 321. The location-based reward generator 321 accesses the reward database 327 to obtain available rewards in response to a reward request generated by a mobile device, such as mobile device 310. The location-based reward generator 321 uses location information for the mobile device provided by the location resolution system 312 in order to determine the available rewards in the location surrounding the mobile device 310. A radius, for example, may be set by the entity creating the reward or set by default in the reward database 327. If a user is within the set radius, then the reward will be identified by location-based reward generator 321.

In response, the reward notification system 323 sends a reward notification to the mobile application 314. The reward notification includes sufficient data to enable a user to understand the scope and content of the reward. For example, the reward notification may indicate that a new item will be available in the user's mobile application if the user claims the reward. The reward notification may indicate that a particular number of in-mobile application credits will be awarded if the user responds to the reward notification.

The reward notification sent by the reward notification system 323 includes sufficient data that the mobile application 314 can pinpoint the reward on a map or otherwise inform a user of the mobile application 314 of the location and the reward. The reward notification may also describe the steps necessary to obtain the reward. These steps may be set by the entity offering the reward or may be default steps, such as travelling to the location and merely launching the mobile application.

Once a user has travelled to the location, the mobile application 314 may be used to claim the reward. This process may involve launching the mobile application 314 and pressing a “claim” button or similar functionality. Alternatively, this process may be more involved, such as interacting with an augmented reality game so as to “capture” or otherwise obtain an item only visible as a rendered part of an augmented reality visible on the mobile device. Yet still further alternatively, the user may be required to purchase a specific item or to make a purchase of a certain size in order to claim the reward.

Still further alternatively, claiming the reward may require a user to take and upload a photograph of him or herself, a product, person, sign, receipt, bar code, QR code, label or other image. The receipt, bar code, QR code or similar indicia may be unique or contain unique data to a single reward claim such that a single receipt, bar code, QR code or similar indicia may not be used multiple times to claim the same reward. Many alternatives for claiming the reward may be available. These may be predetermined by default or may be set by the entity offering or sponsoring the reward.

The reward notification generated by the reward notification system 323 may appear as a pop-up, an in-mobile application 314 notification, a link, a hyperlink, a button or other notice within the mobile application 314. This reward notification appears within the mobile application 314 (or may appear externally from the mobile application) and indicates that the reward for the mobile application 314 is available at a location.

The reward redemption processor 325 includes logic programmed to enable the reward server 320 to confirm that the mobile application 314 has been used as directed so as to claim the reward. For example, if travel to a location is all that is required, then the reward redemption processor 325 will confirm that location data provided by the mobile application 314 matches that required before the reward may be claimed. If travel to a location within a specific radius is required, that will be confirmed by the reward redemption processor 325. For example, travel to a location may be required to be quite close in order to ensure that a user is actually at the location requested by the entity making the reward available.

If more is required, the reward redemption processor 325 will confirm those additional steps. For example, a user may provide a redemption code displayed on the mobile device screen to a sales associate for scanning or direct entry into a POS terminal. In another example, if an evaluation of an image is necessary, the reward redemption processor may automatically or in conjunction with an operator, confirm that the appropriate image has been uploaded. For example, bar codes or other codes visible on a receipt may be confirmed without user intervention. However, recognizing a unique individual and a sign may require human interaction.

The reward database 327 includes rewards, their locations and the steps necessary to claim those rewards. Rewards include, at a minimum, an unlock of enhanced functionality of the requesting mobile application. Rewards may also include tangible rewards, such as offers of free products or services, offers of discounts, offers of tax free purchases, offers of buy one get one free, offers of free prizes with purchase. These tangible rewards may be set by the entity making the reward.

For example, a furniture store may wish to drive customers to their store in order to increase sales. The furniture store may choose to enable a user to receive 300 credits in a particular mobile application for travel to and a check-in at a location. Those 300 credits may be used to enhance functionality of the mobile application. The furniture store may choose to only enable users of a particular mobile application to be notified of the available reward. Alternatively, the furniture store may allocate a pre-determined dollar amount that may be used across multiple mobile applications serviced by the reward server 320. That predetermined dollar amount may result in different rewards being available for different mobile applications, but those rewards will be set based upon the dollar value and, in each case, will provide enhanced functionality to the mobile application.

In addition, the furniture store may provide a tangible reward of a discount of, for example, 15% off the first $1000 spent at the store. This reward may be provided to further encourage sales while the user is in the store. In some situations, this tangible reward may not be desired. Merely encouraging the user to visit a location may be sufficient to encourage sales. The determination whether or not to provide a tangible reward in addition to the reward may be made by the entity offering the reward.

The location or locations of the reward are stored in the reward database 327. For example, the reward may require a user to check-in at a single location. The reward database 327 may require that a user travel very close or within a location—sufficiently close to ensure that the individual operating the mobile application has actually visited the location. The proximity may be determined by default or may be set by the entity making the reward available. A reward may require a user to check-in, over the course of a predetermined time, at a series of locations before the reward maybe claimed. This may be set by the entity offering the reward. If so, the reward database 327 will include this information and any predetermined time period.

The steps necessary to claim a reward are also stored in the reward database 327. These steps may be default steps or steps required by an entity (such as the operator of a business at the location) making the reward available. An interface to the reward database 327 may be made available to entities making rewards available so as to enable those entities to select and/or set the steps necessary to claim a reward.

These steps may be, as described above, a series of check-ins. Alternatively, these steps may be a check-in followed by an image including a location-generated bar code, QR code, receipt or other tangible indication of the user's presence. The steps may include taking a photograph holding a particular product or at the location with a visible sign. These steps will be a part of the reward database 327 and will be communicated to the user along with the location and the available reward in the reward notification sent by the reward notification system 323.

The reward confirmation processor 329 interfaces with the confirmation server 330 that may be operated by or available to the entity making the reward available. The reward confirmation processor 329 provides data to the confirmation server 330 sufficient to demonstrate that the reward was claimed as was required by the reward in the reward database 327 (and as set by the entity offering the reward). This data may be a summary provided daily, weekly, monthly or in real-time such that each redemption results in an update to the entity making the reward available as to the current status of the reward redemption by users. In this way, a particular budget may be set in the reward database 327 and/or the confirmation server 330. Once that budget is reached, the reward may be discontinued or no longer available. The budget may be set to reset after a particular time period has elapsed or upon the occurrence of a particular event, such as a “winning” reward redemption offered, for example, to the 100th check-in.

The confirmation server 330 may be or be a part of a point of sale (POS) system. A user's receipt of and/or use of a tangible reward may be confirmed by a number of methods. First, the release of a code, bar code, QR code or other type of discount indicia itself may be noted by the reward server 320 and, upon request or periodically, confirmed to the confirmation server 330. Alternatively, a code, bar code, QR code or other type of discount indicia may be entered or scanned by a salesperson at the POS directly from a mobile device or from a printout created by the mobile device and printed either at the location or at another location by the user of the mobile device. Still further alternatively, credit card information for the user of the mobile application may be matched by the confirmation server to determine that the user of the mobile application made a purchase using the tangible reward. In this way, a purchase using the tangible reward may be independently verified by the entity making the reward available.

Description of Processes

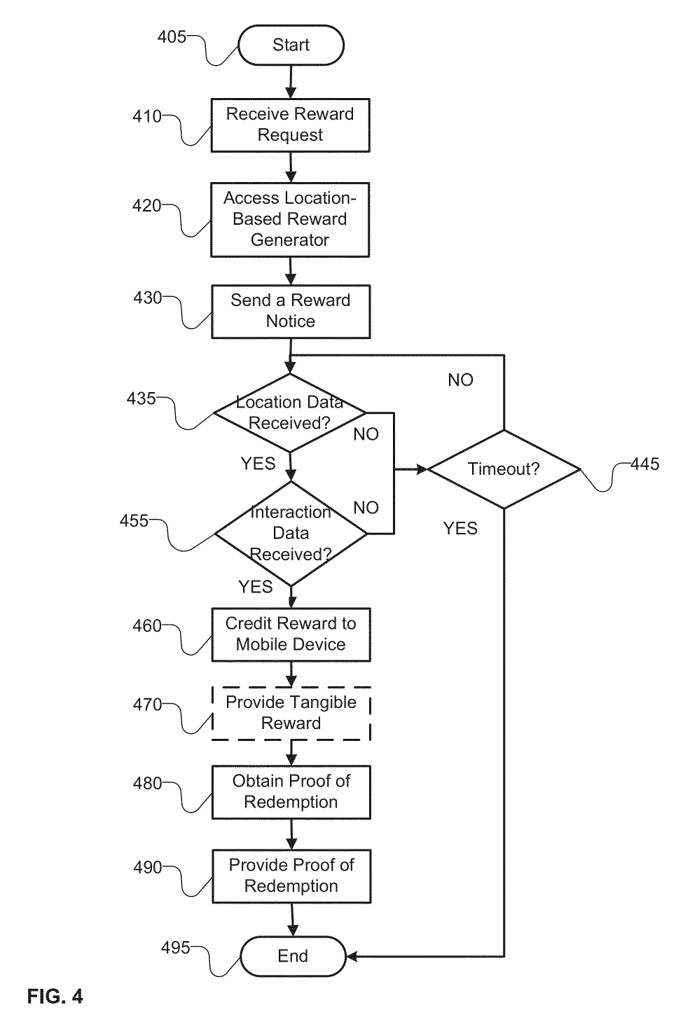

FIG. 4 is a flowchart of a location-aware mobile game reward system for encouraging real-world activity from the perspective of a reward server. The flow chart has both a start 405 and an end 495, but the process may be cyclical in nature. Portions of the process may be accomplished in parallel or serially. Multiple instances of the process may take place simultaneously.

First, the reward server, such as reward server 320, receives a reward request at 410. This reward request may be generated at launch of a mobile application on a mobile device, such as mobile device 310. The reward request may be generated in response to a determination that the mobile device 310 has moved to a new location, for example, one nearer to additional rewards. Alternatively, the reward request may be generated at the request of a user of a mobile application on a mobile device. Further alternatively, the reward request may be generated in response to a particular event in the mobile application.

The reward request may include the current location of the mobile device and the mobile application that generated the request. The reward request may also include information pertaining to other mobile applications on the mobile device that are enabled to receive rewards. The reward request may take place without user interaction and without the direct knowledge of the user of the mobile application.

In response to the reward request, the reward server may access the location-based reward generator at 420. This may be the location-based reward generator 321. As described above, the location-based reward generator 321 uses the current location of the mobile device to generate a reward notice including one or more rewards available within a predetermined radius of the mobile device.

A reward notice may then be sent to the mobile device at 430. This may be completed by the reward notification system 323. The reward notice may include one or more available rewards. As described above, the notice may further include the steps necessary to claim the reward.

The reward server, such as reward server 320, may then await location data and interaction data. So long as location data is not received, the reward server awaits for it at 435. When location data is received indicating that a mobile device is in a location associated with the reward at 435, the reward server awaits for interaction data at 445.

The interaction data is data indicating that the user has interacted with the mobile application on the mobile device as prescribed by the reward. So long as interaction data is not received, it is awaited for by the server. A failure to receive location data and interaction data before a timeout at 445 results in continued waiting. A timeout may also be set after which the reward may no longer be redeemed.

Once location data and interaction data are received, the reward may be credited to the mobile application operating on the mobile device at 460. This reward may be in the form of enhanced functionality or credits that may be redeemed for enhanced functionality within the subject mobile application. This credit may be awarded by the reward server 320 operating in conjunction with other servers that are used to operate the mobile application 314. For example, the reward server 320 may communicate with the servers of the mobile application (which may be the confirmation server 330) in order to credit the mobile application associated with the mobile device the reward. The reward will, thereafter, be available in the mobile application.

As a part of this same process, a tangible reward, as described above, may also be provided at 470. This is shown in a dashed outline because it is an optional aspect of the process.

The reward server may then obtain proof of redemption. This proof may be the location data and/or the interaction data. This proof may also be or include the user of the mobile application taking a picture of a bar code, QR code or a receipt. This proof may also be or include near field communications (NFC) indicating that a particular user, one who was credited with the reward, has provided NFC identification to a point of sale terminal at the location. Other mechanisms for confirming redemption of the offer may be provided.

The proof of redemption may then be provided to the confirmation server at 490. The confirmation server 330 may be a server associated with the mobile application, a server associated with the entity making the offer or may be a third party server. This proof enables the entity making the offer, the entity providing the mobile application enhancement (which may be the same or different entities) with evidence of the reward redemption.

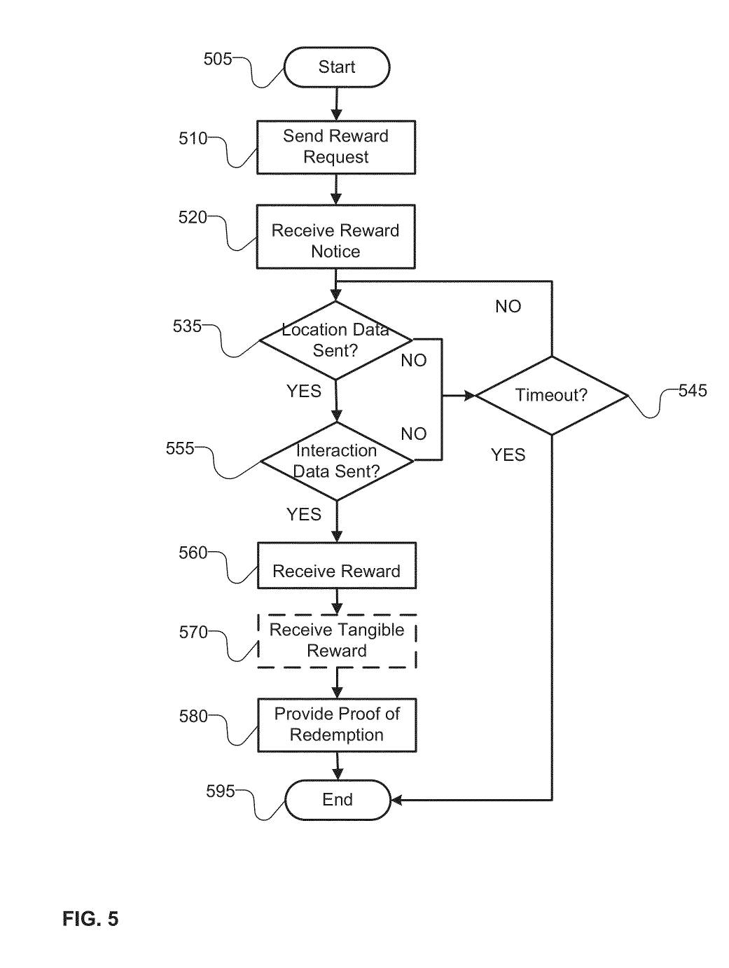

Turning now to FIG. 5, a flowchart of a location-aware mobile game reward system for encouraging real-world activity from the perspective of a mobile application is shown. The flow chart has both a start 505 and an end 595, but the process may be cyclical in nature. Portions of the process may be accomplished in parallel or serially. Multiple instances of the process may take place simultaneously.

The process begins with a mobile application operating on a mobile device sending a reward request at 510. This request may be sent without user intervention and without overt action on the part of the user. This request is described in more detail above.

In response to the request, the mobile application may receive a reward notice including the content of, location of, and steps for obtaining at least one reward. For example, the reward notice will indicate that a reward of 300 credits in the mobile application, that a user is currently using, are available at a particular location if the user checks into that location before 3 o'clock today. This reward notice may be presented in such a way that the user of the mobile application can interact with it so as to obtain additional information pertaining to the reward, the location and the steps necessary to obtain the reward.

In response, the user may travel to the location in order to obtain the reward. Once there, the user may operate the mobile application again in order to send location data at 535 indicating that the mobile application is being operated at the location. The user may then use the mobile application to send interaction data at 555 indicating that the user has interacted with the location, using the mobile application, in a manner indicated by the reward notice. If either does not take place, unless a timeout has occurred at 545, the mobile application will continue to await the location data and interaction data.

Once both location data and interaction data are received, the reward may be received at 560. This may show up as a credit, returning to the example above, of 300 credits in the mobile application that was used to receive the reward notice and to redeem the reward notice. This may appear in game virtually immediately. In some cases, a verification process may take place that requires some time.

In addition, the user may also receive a tangible reward at 570. This may take the form of a digital coupon for use in the location. Returning to the example above, this may take the form of an on-screen bar code that, when scanned by the location, provides a 15% discount on furniture up to $1000. This tangible reward may also be a coupon code, a QR code, or simply an on-screen indication of a discount. The tangible reward may also direct a user to a website in order to enter contact information for a gift, future discount or other tangible reward.

Once the reward is redeemed, for example, by scanning the barcode, that may provided the proof of redemption at 580. Use of the barcode or other key information may be stored by the reward server 320 for forwarding to the confirmation server 330 as proof.

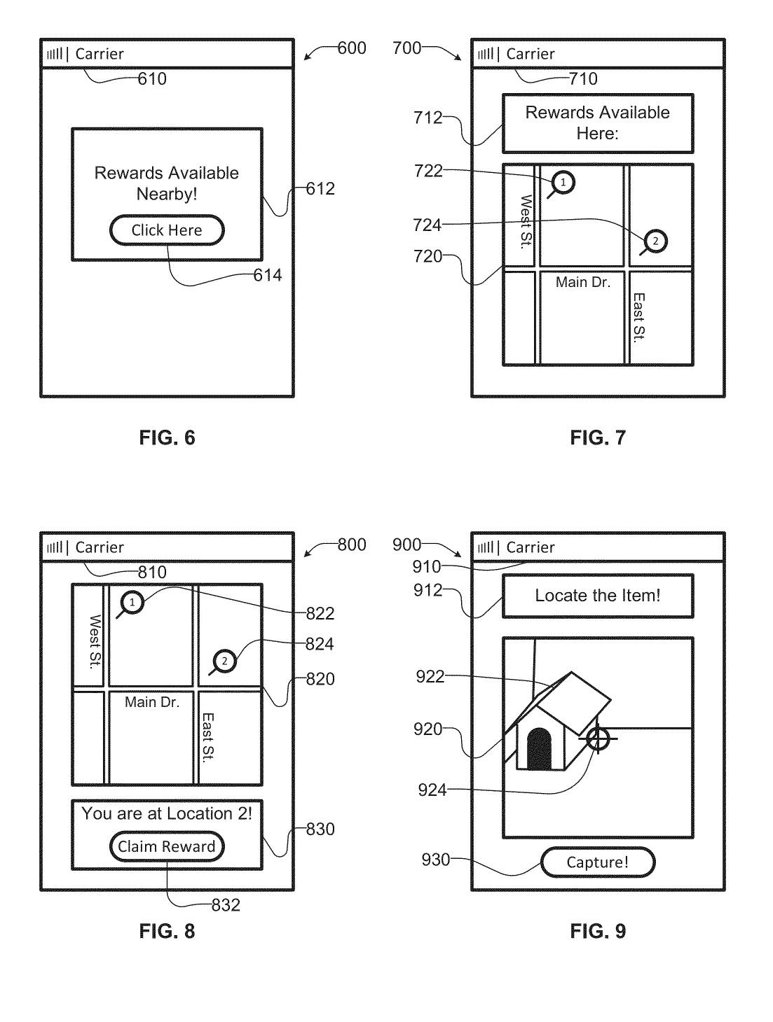

FIG. 6 is an example screen 600 of a mobile application showing a reward notification. This or a similar screen may be shown to a user in a mobile application when a reward notice has been received (in response to a reward request). The title bar 610 of the mobile application shows the carrier and signal strength. A popup window 612 indicates that “Rewards Available Nearby!” and includes a button 614 to view the rewards.

Turning now to FIG. 7, an example screen 700 of a mobile application showing a reward availability map is shown. This screen may be shown, from within the mobile application, once the button 614 is pressed. The title bar 710 remains, but now a text box 712 indicates that rewards are available in the locations identified on the map 720. Location “1” 722 and location “2” 724 are identified by drop pins, but any type of identification may be used. In some cases, a listing of locations may be given in place of map 720. Clicking on either location “1” 722 or location “2” 724 may cause a summary of the available reward to appear along with an address for the reward and any steps necessary to obtain the reward.

FIG. 8 is an example screen 800 of a mobile application showing a reward claim functionality. This is a screen that may be shown once a user arrives at a location where a reward is available. The title bar 810 remains as does the map 820 and location “1” 822 and location “2” 824. Now, a text box 830 indicating that the user is at the location and may claim the reward via a button 832 is also shown.

FIG. 9 is an example screen 900 of a mobile application showing an augmented reality reward claim functionality Instead of merely clicking a button 832 as shown in FIG. 8, the user may be required by the entity offering the reward to utilize an augmented reality game in order to obtain the reward. Title bar 910 remains in this figure while the augmented reality functionality is enabled. Here, a textbox 912 is shown indicating that the user is to find the item in the location. The item may be “hidden” and visible only through the application working in conjunction with the mobile device's camera.

The mobile application may provide a viewfinder 920 in which an image of the location is projected. A cross-hair 924 or circular area may be provided for the user to identify the item in the physical world. Once the user has positioned the crosshair over the item 922, the user may select the capture button 930 in order to obtain the item 922. The item 922 may be digitally inserted into the field of view of the camera so as to be superimposed over the picture and to appear as though it is in the location. The item (or other associated reward) may then be rewarded. In some cases, a series of items at a series of locations may be captures before a reward is given.

This functionality may be augmented by the mobile application itself. For example, a “detective” game could require a user to “solve a crime” by discovering a series of clues. Once all the clues at various locations are discovered, the reward, related or unrelated to the objects discovered, may then be given to the user.

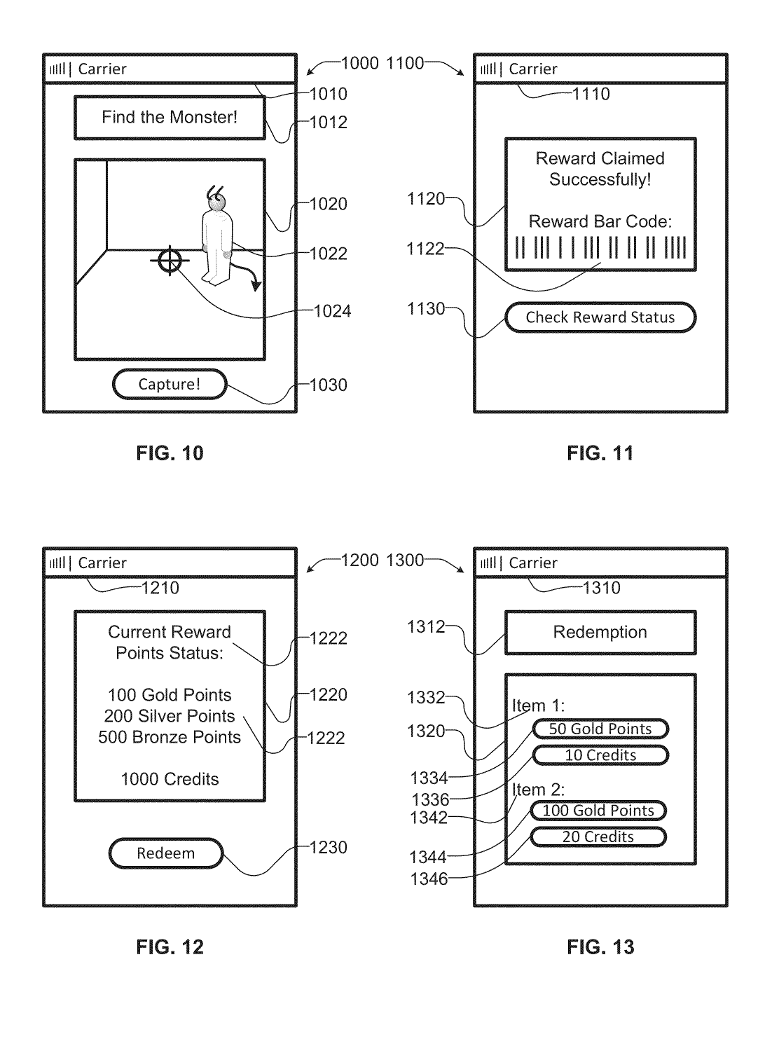

FIG. 10 is an example screen 1000 of a mobile application showing an alternative augmented reality reward claim functionality. In this example, the title bar 1010 remains, but the direction given to the user by the text box 1012 is to find the monster in the location. The mobile application presents the user with a viewfinder 1020 through which the camera of the mobile device projects the view of the location and onto which a monster 1022 may be superimposed. The crosshairs 1024 may be used to capture the monster (or eliminate the monster or various other functionalities). In this case, the capture button 1030 enables a user to capture the monster. A reward may be given for capturing the monster in the location.

FIG. 11 is an example screen 1100 of a mobile application showing an award of a tangible reward. The title bar 1110 remains in this image. Now, a reward box 1120 shows that the reward was successfully claimed and offers a bar code 1122 redeemable for a tangible reward in the location. For example, a user who has travelled to a burger place in order to catch a monster and who has then captured the monster, may then, optionally, receive a bar code, such as bar code 1122, redeemable for a free chocolate shake. The check reward status button 1130 is also shown.

Turning now to FIG. 12, an example screen 1200 of a mobile application showing a current reward point status is shown. This example screen may be shown in response to the check reward status button 1130 of FIG. 11. In some cases, the reward may not be immediate. Instead, reward points may be given. The screen 1200 may include the title bar 1210, but now shows a current reward point status text box 1220. The current reward point status 1222 is shown and the point indicators 1224 show how many points of each type are available. A redeem button 1230 which enables reward points to be used to enhance the mobile application is also shown.

These points may be useful in only a single mobile application, that in which the reward was given, or may, alternatively, be redeemable in a series of applications each serviced by the reward server. In this way, a user may accumulate “points” outside of a mobile application and utilize them in any application that is capable of servicing the mobile application via the reward system. The reward may be immediate and in place of points, such as offering an in-application added functionality or items. In other situations, a point system may be used to allocate values associated with obtaining various rewards.

FIG. 13 is an example screen 1300 of a mobile application showing a reward point redemption. This screen 1300 includes the title bar 1310 and a text box 1312 along with a redemption box 1320. The redemption box 1320 enables a user to redeem points of various types for enhancements. In this example, the enhancements are items in a mobile game. In other examples, the enhancements may be increased functionality in a mobile application.

The redemption box 1320 indicates that “Item 1” 1332 may be had by clicking either the 50 gold points button 1334 or the 10 credits button 1336. “Item 2” 1342 may be had by clicking the 100 gold points button 1344 or the 20 credits button 1346. Credits and gold points may have different values, may be obtained by different means and may be kept separate from one another in a system utilizing them.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method comprising:
sending an electronic notice of a reward available in a physical location to a mobile application operating on a mobile device, the mobile application having enhanced functionality available to be enabled by the reward;
receiving location data indicating that the mobile application is operating online and currently at the physical location;
receiving interaction data indicating that a user of the mobile application has interacted with the mobile application in the physical location in a manner prescribed by the entity offering the reward so as to obtain the reward; and
crediting the mobile application with the reward thereby enabling the enhanced functionality of the mobile application.

2. The method of claim 1 wherein the interaction data indicates that the user has completed a task determined by the entity at the location and offering the reward.

3. The method of claim 1 wherein the reward comprises an offer provided by an operator of the physical location.

4. The method of claim 3 further comprising providing proof of the user interaction with the physical location to the operator of the physical location.

5. The method of claim 4 wherein the proof comprises a selected one of the location data and the interaction data.

6. The method of claim 4 wherein the proof comprises a selected one of a scanned portion of a receipt for a purchase at the physical location, a barcode scanned at the physical location, a barcode scanned from the receipt for a purchase at the physical location, and a number input by the user from the receipt for a purchase at the physical location.

7. The method of claim 1 wherein the mobile application is capable of receiving the notice, of sending location data and of providing interaction data to a reward server.

8. The method of claim 1 wherein the mobile application is an interactive game including augmented reality functionality and further wherein the interaction data is generated in response to interaction with the augmented reality functionality at the physical location.

9. Apparatus comprising a storage medium storing a program having instructions which when executed by a processor will cause the processor to:
send an electronic notice of a reward available in a physical location to a mobile application operating on a mobile device, the mobile application having enhanced functionality available to be enabled by the reward;
receive location data indicating that the mobile application is operating online and currently at the physical location;
receive interaction data indicating that a user of the mobile application has interacted with the mobile application in the physical location in a manner prescribed by the entity offering the reward so as to obtain the reward; and
credit the mobile application with the reward thereby enabling the enhanced functionality of the mobile application.

10. The apparatus of claim 9 wherein the interaction data indicates that the user has completed a task determined by the entity at the location and offering the reward.

11. The apparatus of claim 9 wherein the reward comprises an offer provided by an operator of the physical location.

12. The apparatus of claim 11 wherein the instructions further cause the process to provide proof of the user interaction with the physical location to the operator of the physical location.

13. The apparatus of claim 12 wherein the proof comprises a selected one of the location data and the interaction data.

14. The apparatus of claim 12 wherein the proof comprises a selected one of a scanned portion of a receipt for a purchase at the physical location, a barcode scanned at the physical location, a barcode scanned from the receipt for a purchase at the physical location, and a number input by the user from the receipt for a purchase at the physical location.

15. The apparatus of claim 9 wherein the mobile application is capable of receiving the notice, of sending location data and of providing interaction data to a reward server.

16. The apparatus of claim 9 wherein the mobile application is an interactive game including augmented reality functionality and further wherein the interaction data is generated in response to interaction with the augmented reality functionality at the physical location.

17. The apparatus of claim 8 further comprising:
a processor
a memory
wherein the processor and the memory comprise circuits and software for performing the instructions on the storage medium.
